(19) United States
(12) Patent Application Publication
(10) Pub. No.: US 2026/0286710 A1
(43) Pub. Date: Sep. 24, 2026

(54) FASTENING DEVICE FOR PANELS, IN PARTICULAR FOR GLASS PLATES

(71) Applicant: MYPRO RESEARCH S.R.L., Thiene (VI) (IT)

(72) Inventor: Giancarlo BRUN, Thiene (VI) (IT)

(73) Assignee: MYPRO RESEARCH S.R.L., Thiene (VI) (IT)

(21) Appl. No.: 19/472,452

(22) PCT Filed: Mar. 25, 2024
(86) PCT No.: PCT/IB2024/052831

§ 371 Date: Oct. 3, 2025

(30) Foreign Application Priority Data
Apr. 5, 2023 (IT) 102023000006678

(51) Int. Cl. E04F 11/18; F16B 2/12; F16B 2/14; F16B 2/16

(52) U.S. Cl. CPC E04F 11/1817; E04F 11/1853; F16B 2/12; F16B 2/14; F16B 2/16; E04F 2011/1831; E04F 2011/1895

(57) ABSTRACT

The present invention relates to a fastening device (10; 110) for a panel (4), in particular for a glass plate (4), said device (10; 110) comprising a first fastening element (20) identifying a first flat gripping surface (21) adapted to be positioned in contact with a first external face (5a) of the panel (4) and a second fastening element (30; 130) identifying a second flat gripping surface (31; 131), parallel to the first flat gripping surface (21), adapted to be positioned in contact with a second external face (5b) of the panel (4). The first fastening element (20) comprises a first connection portion (22) comprising at least a first contact surface (24a, 24b, 24c) and the second fastening element (30; 130) comprises a second connection portion (32) comprising at least a second contact surface (34a, 34b, 34c), wherein the first fastening element (20) is connected to the second fastening element (30; 130) by means of the mutual sliding of said at least a first contact surface (24a, 24b, 24c) with said at least a second contact surface (34a, 34b, 34c). Said at least a first contact surface (24a, 24b, 24c) and said at least a second contact surface (34a, 34b, 34c) are inclined, along a sliding direction(S), at a predetermined angle (A) with respect to the first flat gripping surface (21) so that during the mutual sliding of the fastening elements (20, 30) the first flat gripping surface (21) and the second flat gripping surface (31; 131) approach each other in a parallel manner.

### TECHNICAL FIELD OF THE INVENTION

The present invention falls within the field of the construction of structures with panels, such as partitions or railings or balustrades with panels, preferably made of glass, or doors with leaves preferably made of glass.

In particular, the present invention relates to the system for fastening such panels to a load-bearing support structure.

### DESCRIPTION OF THE STATE OF THE ART

The use of structures with panels for many applications is well known in the construction industry, such as partitions or railings or balustrades, both in residential and public areas, or even doors with leaves comprising glass plates/leaves. In many cases, the panels preferably consist of glass plates to allow the structure to be transparent.

Such structures involve the connection of the panel at one or more of the lateral edges thereof to the load-bearing structure, consisting for example of a masonry column or a door frame.

In systems of the known type, the connection of the panel to the load-bearing structure involves the use of clamping devices in which two metal fastening elements are positioned in contact with the external faces of the panel along an edge thereof, and the two fastening elements are then locked and tightened together by means of fastening screws which affect the two fastening elements and close the elements themselves in a pack-like manner onto the panel.

However, such a solution belonging to the state of the art has some drawbacks.

A drawback of such a system consists of the complexity of the installation steps which require operators to correctly position and fasten the screws until the correct assembly is achieved.

Another drawback of the known type of system consists of the need to use tools to control the tightening torque value to ensure the durability of the fastening over time and/or to avoid the application of excessive forces which could lead to panel breakage, particularly when using panels made of glass plates.

A further drawback of the known type of system lies in the negative aesthetic contribution caused by the use of screws.

Therefore, the main object of the present invention is to solve, or at least partially overcome, the aforementioned drawbacks which characterize the state of the art.

In particular, it is an object of the present invention to propose a solution which allows to simplify the panel installation operations with respect to the known type of systems.

It is another object of the present invention to propose a solution which improves the grip and stability of the panel in the correct position over time with respect to the known type of systems.

It is a further object of the present invention to propose a solution which minimises any breakage of the panel during the installation thereof.

It is another object of the present invention to propose a solution which improves the final aesthetic effect with respect to the known type of systems.

SUMMARY OF PRESENT INVENTION

In a first aspect thereof, the present invention therefore relates to a fastening device for a panel, in particular for a glass plate, said device comprising a first fastening element identifying a first flat gripping surface adapted to be positioned in contact with a first external face of said panel and a second fastening element identifying a second flat gripping surface, parallel to said first flat gripping surface, adapted to be positioned in contact with a second external face of said panel, said first fastening element and said second fastening element being mutually connected to keep said panel in contact therebetween, wherein said first fastening element comprises a first connection portion comprising at least a first contact surface and said second fastening element comprises a second connection portion comprising at least a second contact surface, wherein said first fastening element is connected to said second fastening element by means of the mutual sliding of said at least a first contact surface with said at least a second contact surface when said fastening elements mutually slide along a sliding direction, wherein said at least a first contact surface and said at least a second contact surface are inclined along said sliding direction, at a predetermined angle with respect to said first flat gripping surface, so that during said mutual sliding of said fastening elements along said sliding direction said first flat gripping surface and said second flat gripping surface approach each other in a parallel manner.

Preferably, said predetermined angle of inclination has a value comprised between 0.1° and 45°, preferably a value comprised between 1° and 20°, and even more preferably a value comprised between 1° and 5°.

In a preferred embodiment, the first flat gripping surface is defined in a first gripping element associated with the first fastening element and/or the second flat gripping surface is defined in a second gripping element associated with the second fastening element.

According to a preferred embodiment, the fastening device of the invention comprises one or more spacer elements associated with the first fastening element to adjust the position of the first gripping element and/or comprises one or more spacer elements associated with the second fastening element to adjust the position of the second gripping element.

Preferably, the first flat gripping surface is made of a material with a high friction coefficient and/or the second flat gripping surface is made of a material with a low friction coefficient adapted to favour the sliding on the second external face of the panel.

In a preferred embodiment, the second fastening element comprises a plurality of rolling means having respective contact zones for the second external face of the panel, wherein said contact zones lie on a plane defining the second flat gripping surface, or the first fastening element comprises a plurality of rolling means having respective contact zones for the first external face of the panel, wherein said contact zones lie on a plane defining the first flat gripping surface.

According to a preferred embodiment, the first connection portion comprises a plurality of first contact surfaces and the second connection portion comprises a plurality of second contact surfaces, wherein the first fastening element is connected to the second fastening element by means of the mutual sliding of the plurality of first contact surfaces with the plurality of second contact surfaces when the fastening elements mutually slide along the sliding direction, wherein the plurality of first and second contact surfaces are parallel to each other and inclined, along the sliding direction, at said predetermined angle with respect to the first flat gripping surface.

Preferably, the fastening device comprises connection means for connecting to a load-bearing structure.

In a preferred embodiment, the connection means are associated with the first fastening element or with the second fastening element.

According to a preferred embodiment, the connection means comprise one or more fastening screws and/or one or more dowels.

Preferably, the fastening device of the invention is part of a hinge connecting to a load-bearing structure.

### BRIEF DESCRIPTION OF THE DRAWINGS

Further advantages, objects and features as well as embodiments of the present invention are defined in the claims and will be clarified hereinafter by means of the following description, in which reference is made to the accompanying drawing tables. In particular, in the figures:

FIG. 1 shows a structure obtained using the fastening devices according to a first preferred embodiment of the invention;

FIG. 1A shows an enlarged detail of FIG. 1;

FIG. 2 shows an axonometric view of a fastening device used in the embodiment of the structure of FIG. 1;

FIG. 3 shows an exploded view of the fastening device of FIG. 2;

FIG. 4 shows an element of the fastening device of FIG. 3 isolated from the rest;

FIG. 5 shows another element of the fastening device of FIG. 3 isolated from the rest;

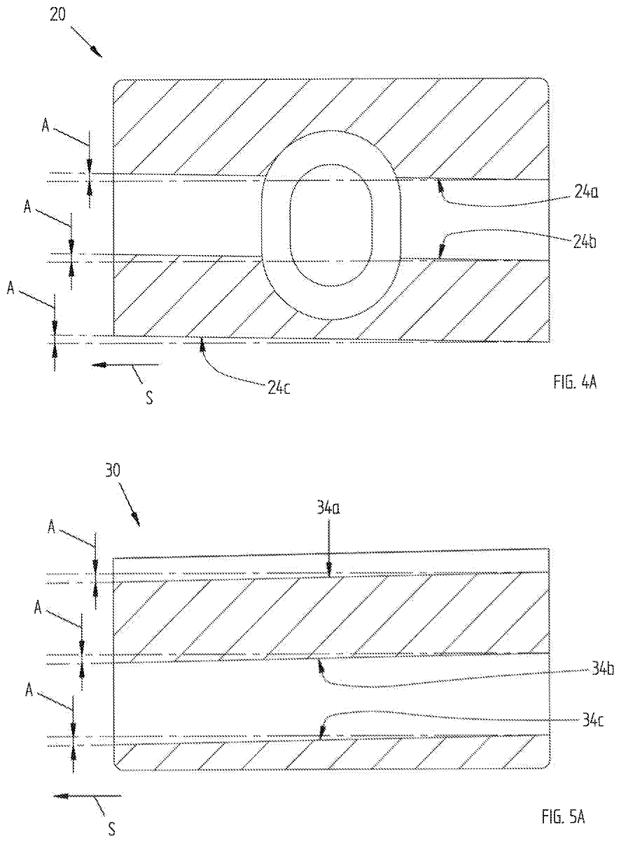

FIG. 4A shows a plan view of the section along the line IV°-IV° of FIG. 4;

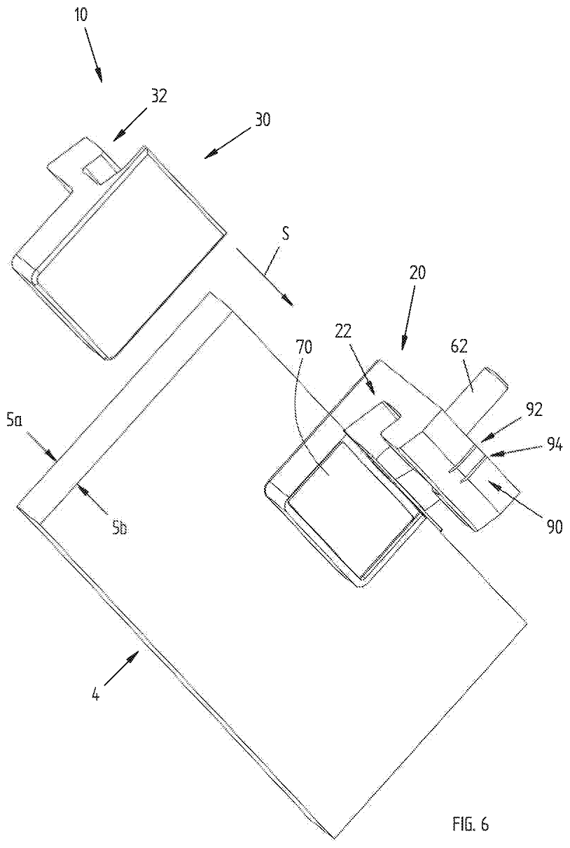

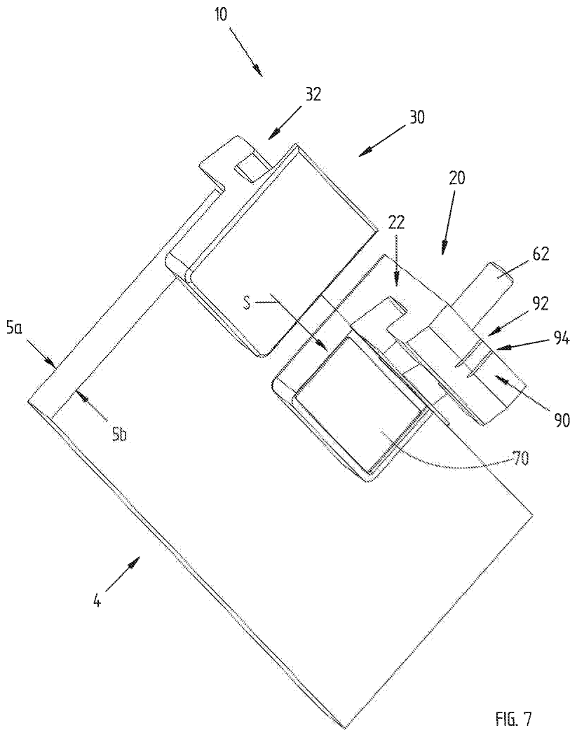

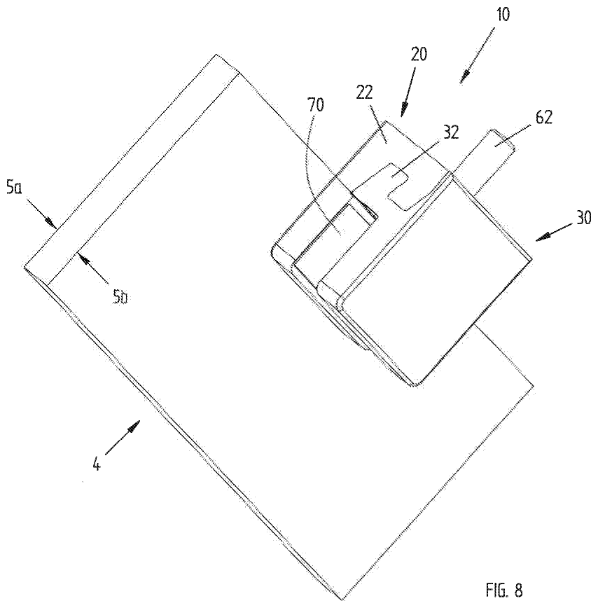

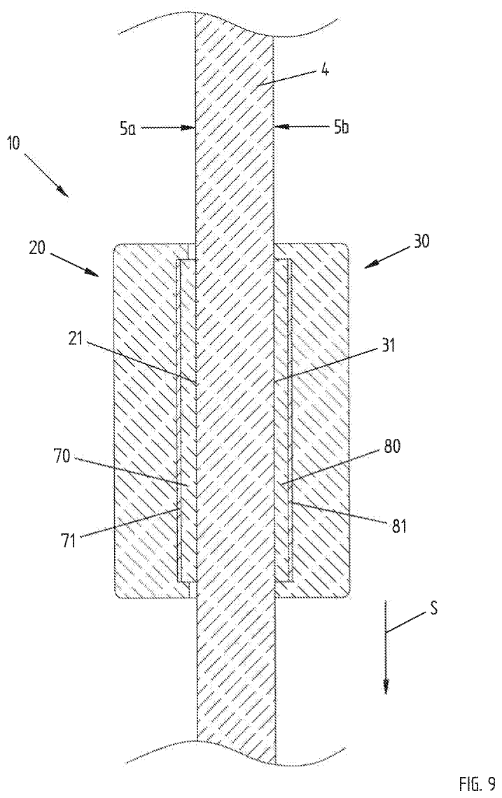

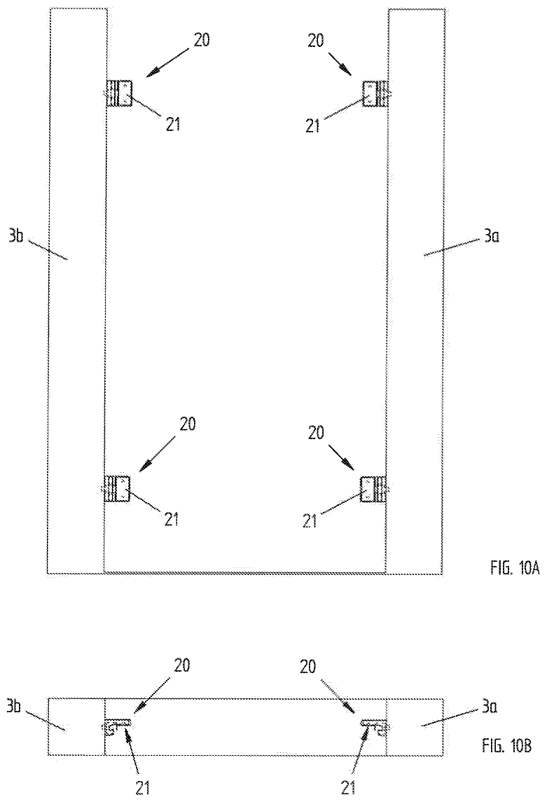

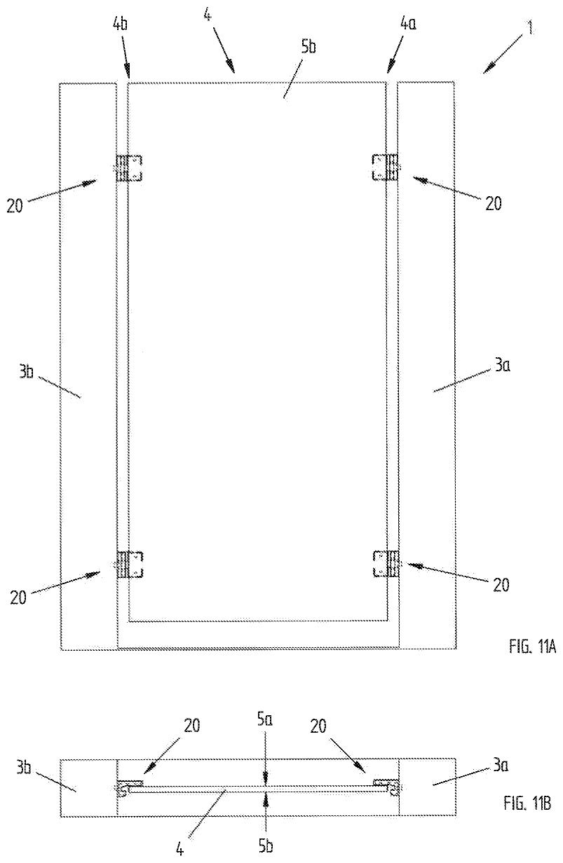

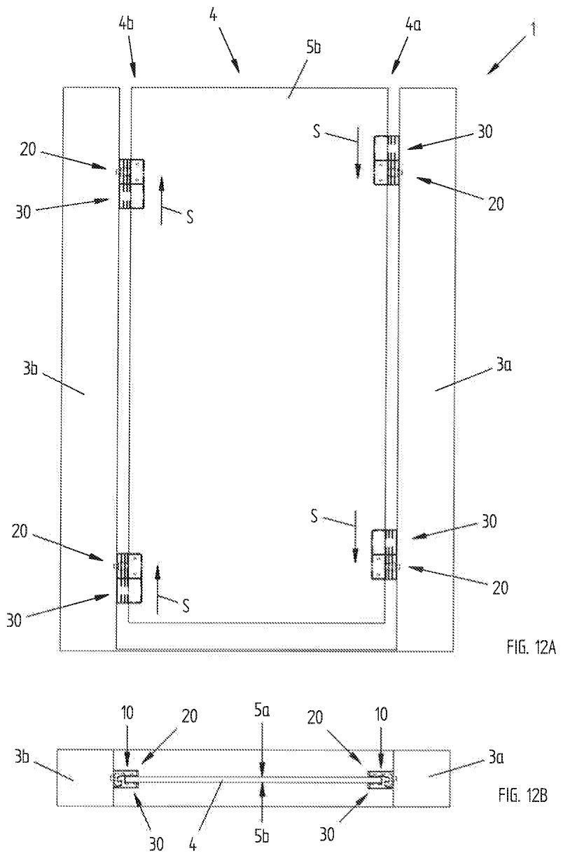

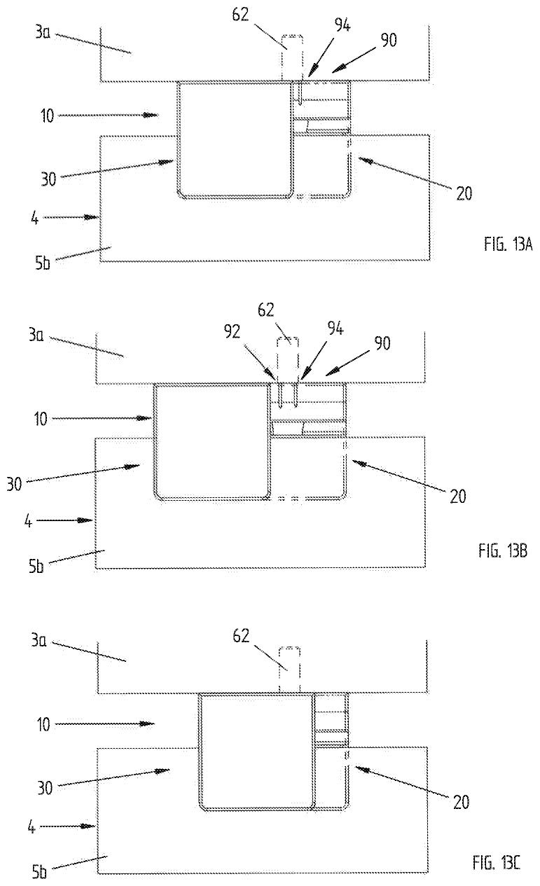

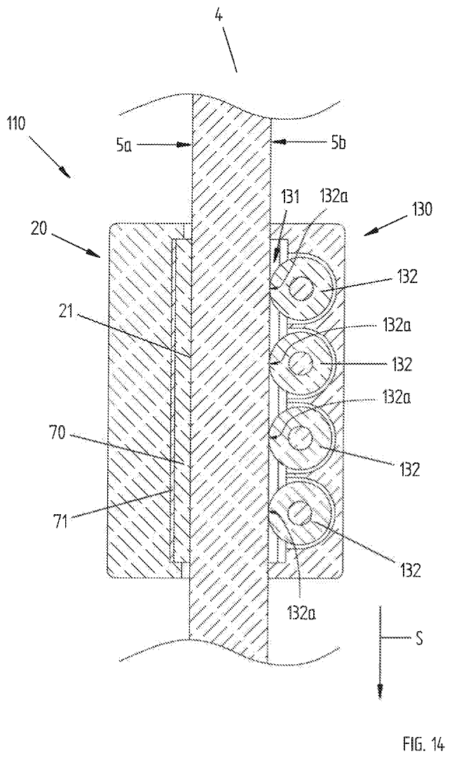

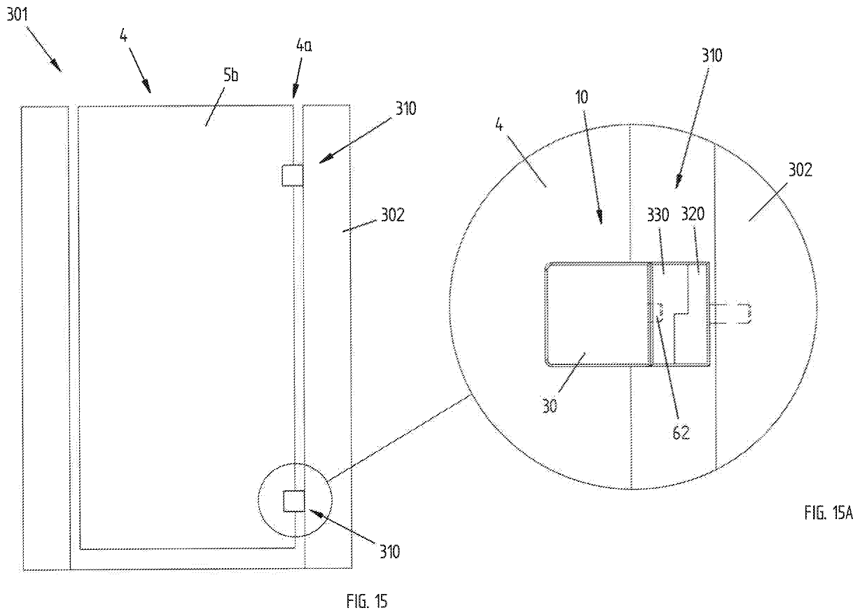

FIG. 5A shows a plan view of the section along the line V°-V° of FIG. 5;

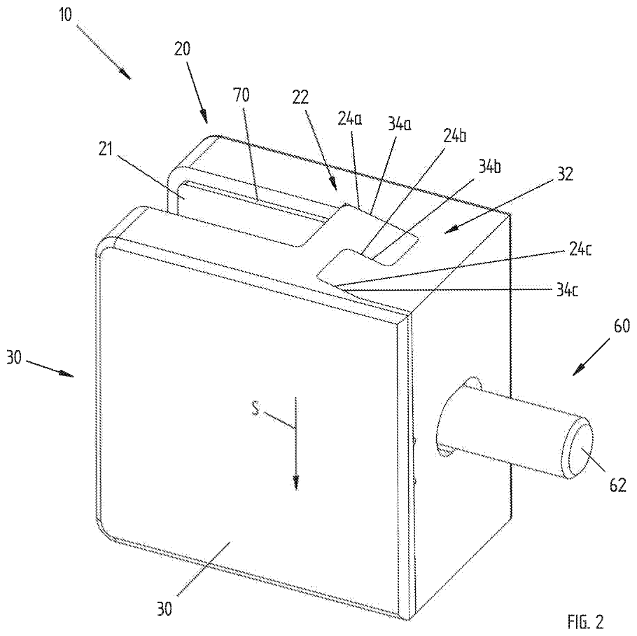

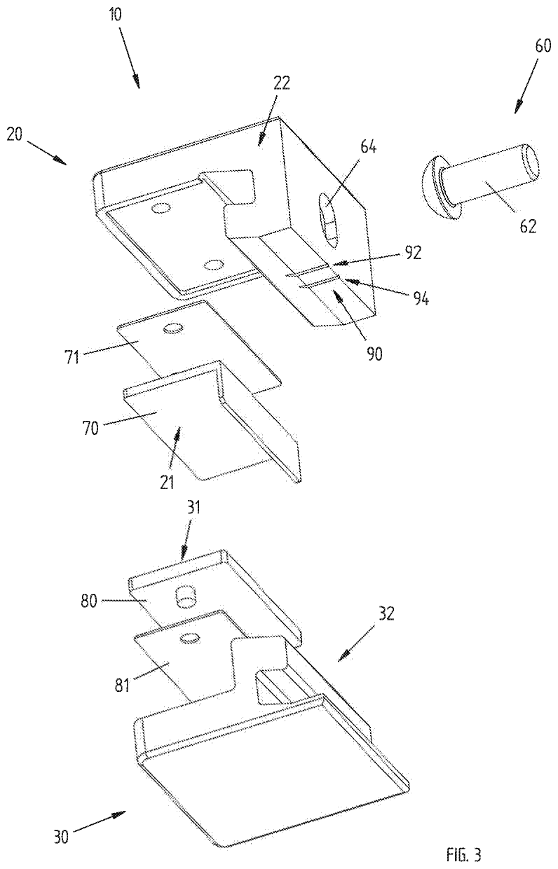

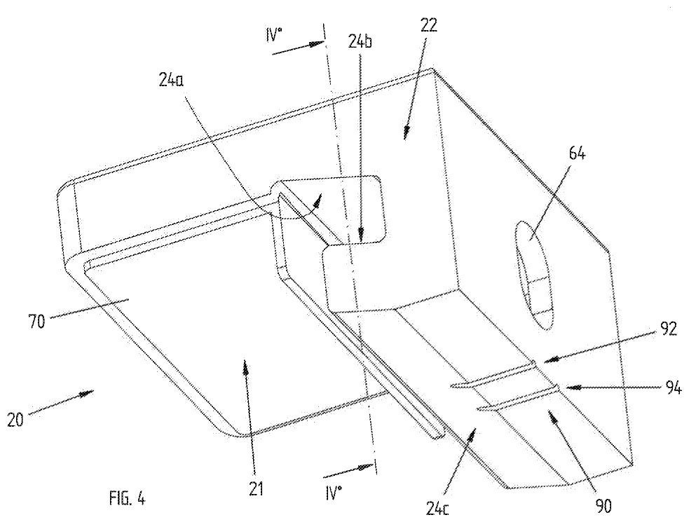

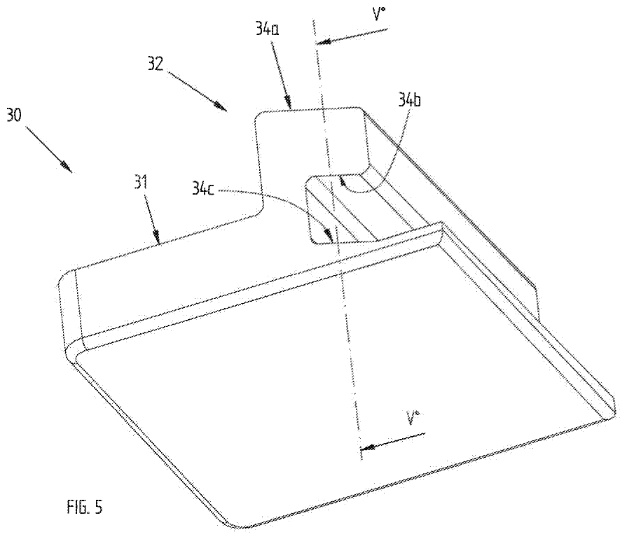

FIG. 6 shows an axonometric view of the fastening device of FIG. 2 in a first installation step to a glass plate;

FIG. 7 shows an axonometric view of the fastening device of FIG. 2 in a second installation step to the glass plate;

FIG. 8 shows an axonometric view of the fastening device of FIG. 2 in the final position installed on the glass plate;

FIG. 9 shows a plan view of a cross-section of the assembly of FIG. 8;

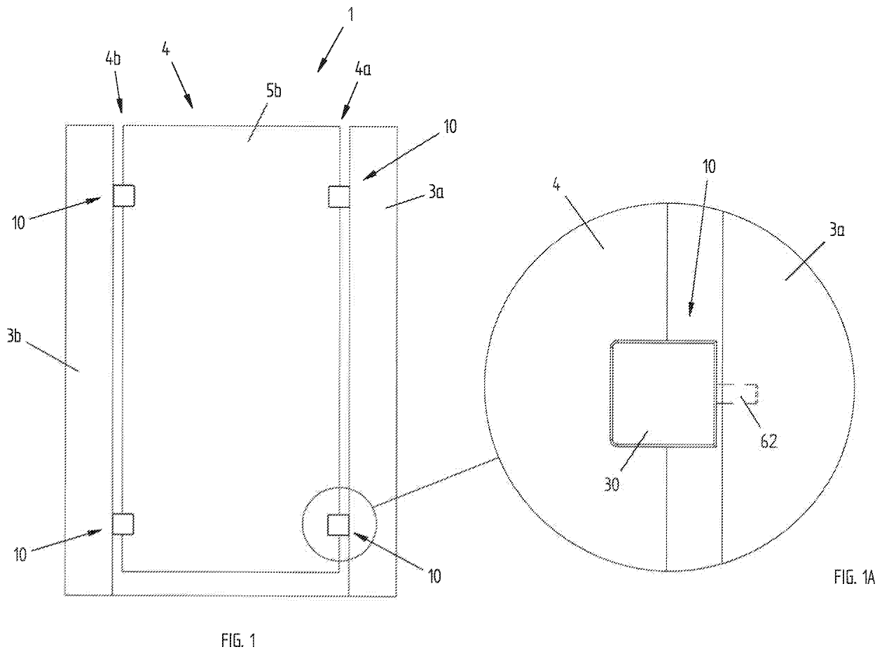

FIG. 10A shows a first step of making the structure of FIG. 1;

FIG. 10B shows a plan view from above of FIG. 10A;

FIG. 11A shows a second step of making the structure of FIG. 1;

FIG. 11B shows a plan view from above of FIG. 11A;

FIG. 12A shows a third step of making the structure of FIG. 1;

FIG. 12B shows a plan view from above of FIG. 12A;

FIGS. 13A, 13B and 13C show a plan view of the fastening device of FIG. 2 in possible configurations during the installation thereof;

FIG. 14 shows an embodiment variant of the section of FIG. 9 related to an embodiment variant of the fastening device of the invention;

FIG. 15 shows a structure obtained using the fastening devices according to a preferred embodiment variant of the invention;

FIG. 15A shows an enlarged detail of FIG. 15.

### DETAILED DESCRIPTION OF SOME PREFERRED EMBODIMENTS OF THE PRESENT INVENTION

Although the present invention is described below with reference to embodiments thereof depicted in the drawing tables, the present invention is not limited to the embodiments described below and depicted in the drawing tables. On the contrary, the embodiments described below and depicted in the drawing tables clarify certain aspects of the present invention, the object of which is in any case defined by the claims.

The present invention finds particular application in the construction field for making a partition with glass panels, as described in detail below.

However, it should be noted that the present invention is more generally advantageously applied in the construction of structures with various types of panels where the assembly if structural or furnishing panels are required, such as railings or balustrades with panels preferably made of glass or doors with panels preferably made of glass.

In addition to the glass solutions, the panels can also be of various types, such as sound-absorbing panels.

In the following with reference to FIGS. 1 to 13, a first embodiment of the fastening device 10 according to the present invention and a use thereof for making a partition 1 will be described.

The fastening device 10 according to such a preferred embodiment is associated with a panel 4, preferably consisting of a glass plate 4.

The panel 4 is generally characterised by a plate-like shape in which external faces 5a, 5b which are parallel, or substantially parallel, are identified. It should also be noted that the external faces of the panel may not be parallel for the entire extension thereof, e.g., they may bear raised aesthetic motifs or the like. In the context of the present invention, however, it is considered important that the parallel external faces 5a, 5b of the panel are parallel at least in the area at the fastening device 10.

FIG. 1, for example, shows a partition 1 comprising a glass plate 4 fastened to a load-bearing structure, defined for example by two masonry columns 3a, 3b, by means of four fastening devices 10 according to the invention.

In preferred embodiment variants, however, the load-bearing structure can be any structure adapted to receive a panel, preferably a glass plate. For example, the load-bearing structure can consist of the frame of a door leaf, or the load-bearing structure can be the frame 302 of a door 301 in which the leaf consists of the panel 4 itself. In such a case, the fastening device 10 according to the invention can be part of a hinge 310, as shown for example in FIGS. 15 and 15A.

In the embodiment illustrated, the panel consisting of the glass plate 4 is preferably rectangular in shape. In preferred embodiment variants, the panel can have different shapes.

In FIG. 1, the four fastening devices 10 are associated with the left and right side edges 4a, 4b of the glass plate 4. In embodiment variants, however, the fastening devices used may differ in number with respect to the four shown in FIG. 1, depending on the size and/or weight of the panel to be fastened.

Furthermore, the various fastening devices used for the panel will be essentially the same as each other. For this purpose, reference will be made in the following description to one of such fastening devices, it being understood that what is described may be extended mutatis mutandis to the other fastening devices.

The fastening device 10 according to the invention preferably comprises a first fastening element 20 adapted to be positioned in contact with a first external face 5a of the glass plate 4 and a second fastening element 30 adapted to be positioned in contact with a second external face 5b of the glass plate 4.

In their final assembled configuration, the first fastening element 20 and the second fastening element 30 are mutually connected to grip the glass plate 4 therebetween, as described in more detail below.

The first fastening element 20 identifies a first flat gripping surface 21 adapted to be positioned in contact with the first external face 5a of the glass plate 4 and the second fastening element 30 identifies a second flat gripping surface 31 adapted to be positioned in contact with the second external face 5b of the glass plate 4. The second flat gripping surface 31 of the second fastening element 30 is parallel to the first flat gripping surface 21 of the first fastening element 20.

Preferably, the first flat gripping surface 21 is made of a material with a high friction coefficient adapted to ensure an adequate grip on the first external face 5a of the glass plate 4. For example, such a material is preferably rubber.

Preferably, the second flat gripping surface 31 is made of a material with a low friction coefficient adapted to favour the sliding thereof on the second external face 5a of the glass plate 4. For example, such a material is preferably PVC or Nylon.

In the illustrated and described embodiment, preferably, the first flat gripping surface 21 is defined in a first gripping element 70 associated with the first fastening element 20. Preferably the first gripping element 70 is made of a material with a high friction coefficient, e.g., made of rubber.

Similarly, the second flat gripping surface 31 is preferably defined in a second gripping element 80 associated with the second fastening element 30. Preferably the second gripping element 80 is made of a material with a low friction coefficient, e.g., PVC or Nylon.

In the embodiment illustrated and described, preferably, one or more spacer elements 71 are associated with the first fastening element 20 and allow the adjustment of the position of the first gripping element 70, as further described below. Only one spacer element 71 is shown in the figures by way of illustration. In embodiment variants, the number of spacer elements 71 actually used may be different, viz., two or more intermediate spacer elements. The number of spacer elements 71 actually used will preferably be defined during installation, as described below. Furthermore, in a possible embodiment variant, no spacer elements can be used.

Similarly, one or more spacer elements 81 are associated with the second fastening element 30 and allow the adjustment of the position of the second gripping element 80, as further described below. Only one spacer element 81 is shown in the figures by way of illustration.

In embodiment variants, the number of spacer elements 81 actually used may be different, viz., two or more intermediate spacer elements. The number of spacer elements 81 actually used will preferably be defined during installation, as described below. Furthermore, in a possible embodiment variant, no spacer elements can be used.

Preferably, the spacer elements 71, 81 are made of a rigid material, such as a rigid plastic material or a metal.

Preferably, the gripping elements 70, 80 and/or the spacer elements 71, 81 each have a plate-like shape with a thickness which keeps constant for the entire extension thereof.

The first fastening element 20 comprises a first connection portion 22 and the second fastening element 30 comprises a corresponding second connection portion 32 adapted to interact with the first connection portion 22 of the first fastening element 20.

The first connection portion 22 and the second connection portion 32 comprise respective shaped portions with conjugate geometries which allow the interlocking and the mutual sliding of the two fastening elements 20, 30 along a mutual sliding direction S.

Preferably, during the mutual sliding steps of the fastening elements 20, 30 only one of the two fastening elements 30 is slid while the other fastening element 20 is kept stationary.

On the first connection portion 22 of the first fastening element 20, three contact surfaces 24a, 24b, 24c parallel to each other are preferably identified, and on the second connection portion 32 of the second fastening element 30, three corresponding contact surfaces 34a, 34b, 34c parallel to each other are preferably identified.

The contact surfaces 24a, 24b, 24c, 34a, 34b, 34c are preferably flat surfaces.

The contact surfaces 24a, 24b, 24c of the first fastening element 20 are arranged in contact with the corresponding contact surfaces 34a, 34b, 34c of the second fastening element 30.

According to an aspect of the present invention, the contact surfaces 24a, 24b, 24c of the first fastening element 20 are inclined, along the mutual sliding direction S, at a predetermined angle A with respect to the first flat gripping surface 21, or the second flat gripping surface 31, the flat gripping surfaces 21, 31 being parallel to each other. The contact surfaces 34a, 34b, 34c of the second fastening element 30 are also inclined, along the mutual sliding direction S, at said predetermined angle A with respect to the first flat gripping surface 21, or the second flat gripping surface 31.

Preferably, said predetermined angle A is comprised between 0.1° and 45°, more preferably comprised between 1° and 20°, and even more preferably comprised between 1° and 5°.

The inclination of the contact surfaces 24a, 24b, 24c of the first fastening element 20 and the contact surfaces 34a, 34b, 34c of the second fastening element 30 causes the mutual approach of the first flat gripping surface 21 of the first fastening element 20 to the second flat gripping surface 31 of the second fastening element 30 when the fastening elements 20, 30 are mutually slid along the sliding direction S.

In particular, the second flat gripping surface 31 of the second fastening element 30 approaches the first flat gripping surface 21 of the first fastening element 20 when the second fastening element 30 is slid along the sliding direction S with respect to the stationary first fastening element 20.

The first flat gripping surface 21 and the second flat gripping surface 31 approach each other in a parallel manner.

As mentioned above and according to the preferred embodiment illustrated, the second fastening element 30 is slid with respect to the first fastening element 20 while the first fastening element 20 is kept stationary.

Preferably, therefore, the fastening device 10 comprises connection means 60 to the load-bearing structure 3a and more preferably connection means 60 associated with the first fastening element 20 which lock the first fastening element 20 to the load-bearing structure 3a.

The connection means 60 comprise, preferably, a fastening screw 62 or dowel 62. The connection means an be of different types and conform, on a case-by-case basis, to the type of load-bearing structure to which the fastening device is connected.

The fastening screw 62 is preferably received in a seat 64 defined in the first fastening element 20.

Preferably, the fastening element which is kept stationary during installation, in the present case the first fastening element 20, is associated with reference means 90 used during installation to define the correct number of spacer elements 71, 81 to be used for correct installation and to obtain the appropriate mutual gripping force exerted by the two fastening elements 20, 30 once the final assembled position is reached.

The reference means 90 comprise, preferably, two reference notches 92, 94 impressed on the first fastening element 20. As described in more detail below, the display or non-display of such reference notches 92, 94 during the installation operations will give the operator useful indications on the correct number of spacer elements 71, 81 to be used.

With reference to FIGS. 10A to 12A, the operating steps of making the partition 1 of FIG. 1 in which the glass plate 4 is installed by means of the use of four fastening devices 10 of the invention are illustrated below.

The first fastening elements 20 of the four fastening devices 10 are fastened to the two masonry columns 3a, 3b, preferably by means of the respective dowels 62 (FIGS. 10A and 10B).

The corresponding spacer elements 71 and the first gripping elements 70 are arranged on the first fastening elements 20.

Next, the glass plate 4 with its first external face 5a is arranged resting on the first fastening elements 20 of the four fastening devices 10, preferably resting on the first flat gripping surfaces 21 of the first gripping elements 70 of the four fastening devices 10 (FIGS. 11A and 11B).

Next, the second fastening element 30 is arranged resting on the second external face 5b of the glass plate 4 and laterally to the first fastening element 20 (FIGS. 12A, 12B and FIG. 7). The second fastening element 30 is then inserted into the first fastening element 20 at the respective connection portions 32, 22. The second fastening element 30 is manually pushed along the sliding direction S with respect to the first fastening element 20 until the second fastening element 30 stops due to the friction generated between the two fastening elements 20, 30 and the glass plate 4 inclusive. During the sliding, in fact, the first and the second flat gripping surface 21, 31 of the first and the second fastening element 20, 30 mutually approach each other in a parallel manner due to the mutual sliding of the inclined surfaces 24a, 34a, 24b, 34b, 24c, 34c, as mentioned above, progressively causing the mutual friction.

The reference notches 92, 94 of the first fastening element 20 are then inspected. FIGS. 13A-13C show the three possible conditions which can arise during said inspection, followed by the necessary adjustment operations, as described below. If in the condition shown in FIG. 13A, viz., only the second notch 92 is visible to the operator, this means that the correct number of spacer adjustment element(s) 71, 81 is currently used.

If in the condition shown in FIG. 13B, viz., the two notches 92, 94 are visible to the operator, this means that the spacer adjustment element(s) 71, 81 currently used are excessive in number and do not allow the subsequent correct assembly of the second fastening element 30 with the first fastening element 20. One or both of the spacer adjustment element(s) 71, 81 are therefore removed until the ideal condition of FIG. 13A is reached.

If in the condition shown in FIG. 13C, viz., neither of the two notches 92, 94 is visible to the operator, this means that the spacer adjustment element(s) 71, 81 currently used are insufficient in number and do not allow the subsequent correct assembly of the second fastening elements 30 with the first fastening element 20. One or more spacer adjustment element(s) 71, 81 is/are therefore added until the ideal condition of FIG. 13A is reached.

At this point the final step can be carried out in which the second fastening element 30 is forced along the sliding direction S with respect to the first fastening element 20 until the second fastening element 30 overlaps the first fastening element 20 in its considered final position.

Preferably, special tools are used to carry out such a final step, which allow the second fastening element 30 to be forcibly pushed along the sliding direction S. For example, a rubber mallet or equivalent tools capable of applying a sufficient thrust force to bring the second fastening element 30 up to the final position overlapping the first fastening element 20 can be used.

Said operations are obviously performed for each of the four fastening devices 10 after which the glass plate 4 is fully assembled.

From what has been described, it is clear that the installation of a glass plate, or a panel in general, is simplified with respect to the known type of systems requiring the use of screws.

The proposed solution also advantageously improves the grip and stability of the panel in the correct position over time with respect to the known type of systems. Advantageously, the risk of breakage is minimised during panel installation.

Furthermore, advantageously, the final aesthetic effect with respect to the known type of systems is improved by the fact that there are no further mutual locking elements between the fastening elements, such as locking screws.

In the embodiment illustrated in FIGS. 1 to 13 and described above, the inclined contact surfaces are preferably three in number for the first fastening element and slide on three respective contact surfaces of the second fastening element. The effect of said inclined surfaces is to allow the parallel approach of the flat gripping surfaces of the two fastening elements to achieve the grip of the glass plate.

However, in embodiment variants, the same effect can be achieved by means of a different number of mutually inclined contact sliding surfaces in the first and in the second fastening element, at most only one inclined contact surface associated with the first fastening element and only one corresponding inclined contact surface associated with the second fastening element.

Furthermore, in the embodiment illustrated in FIGS. 1 to 13 and described above, the inclined contact surfaces are flat surfaces. However, in embodiments, the inclined contact surfaces may not be flat, e.g., surfaces with a curved cross-section capable of mutual sliding, such as surfaces consisting of cylindrical portions.

With reference to FIG. 14, an embodiment variant of the fastening device 110 of the invention is shown which differs from the embodiment described and illustrated above in that the second flat gripping surface 131 of the second fastening element 130 is defined by a plurality of aligned rolling means 132. The component parts which are equivalent to the preferred embodiment described with reference to FIGS. 1 to 13 are identified by the same reference numbers.

According to such an embodiment, the rolling means 132 are arranged so that the respective contact zones 132a to the second external surface 5b of the glass plate 4 to be locked lie on a plane defining the second flat gripping surface 131.

Preferably, the rolling means 132 comprise a plurality of idler rollers suitably mounted on the second fastening element 130.

Preferably, the rolling means 132 are made of rigid material, more preferably made of plastic, e.g., nylon or PVC.

Advantageously, the use of rolling means 132 according to such an embodiment allows to reduce the friction force, now of the rolling type, between the second flat gripping surface 131 and the second external surface 5b of the glass plate 4. This facilitates the installation operations of the fastening device 110 according to the invention and in particular the displacement of the second fastening element 130 along the sliding direction S which requires a reduced thrust force and possibly the manual positioning of the second fastening element 130 in the final position overlapping the first fastening element 20 without the use of dedicated tools.

In the embodiment illustrated and described, preferably, the rolling means are associated with only the second fastening element. In preferred embodiments, the rolling means can be associated with the first fastening element only.

FIGS. 15 and 15A show the use of the fastening device 10 according to the present invention in the creation of a glass door 301.

According to such an embodiment, two fastening devices 10 are associated with the right side edge 4a of the glass plate 4.

The two fastening devices 10 are in such a case part of a respective hinge 310 which allows the connection of the door leaf consisting of the glass plate 4 to the load-bearing structure formed by the frame 302 of the door 301 itself.

The hinge 310 comprises, preferably, a first part 320 which can be fastened to the frame 302 and a second movable part 330 hinged to the first part 320. The fastening device 10 is preferably fixedly connected to the second movable part 330 of the hinge 310, preferably by means of one or more locking screws 62.

During the opening of the door 301 and the rotation of the panel 4, the fastening device 10 together with the second movable part 330 of the hinge 310 rotate with respect to the first part 320.

From what has been described, it can therefore be inferred that the fastening device of the invention allows to achieve the set objects and in particular allows to simplify the installation operations of a panel with respect to the known type of systems.

While the present invention has been described with reference to the particular embodiments depicted in the figures, it should be noted that the present invention is not limited to the particular embodiments depicted and described; on the contrary, further variations of the described embodiments fall within the scope of the present invention, which scope is defined by the claims.

1.-11. (canceled)

12. A fixing device for a panel, said fixing device comprising:
a first fastening element identifying a first flat gripping surface adapted to be positioned in contact with a first external face of said panel; and
a second fastening element identifying a second flat gripping surface, parallel to said first flat gripping surface, adapted to be positioned in contact with a second external face of said panel, said first fastening element and said second fastening element being mutually connected to keep said panel gripped therebetween,
wherein said first fastening element comprises a first connection portion comprising at least a first contact surface,
wherein said second fastening element comprises a second connection portion comprising at least a second contact surface,
wherein said first fastening element is connected to said second fastening element by means of the mutual sliding movement of said at least a first contact surface with said at least a second contact surface when said fastening elements mutually slide along a sliding direction, and
wherein said at least a first contact surface and said at least a second contact surface are inclined, along said sliding direction, at a predetermined angle with respect to said first flat gripping surface so that during said mutual sliding of said fastening elements along said sliding direction said first flat gripping surface and said second flat gripping surface approach each other in a parallel manner.

13. The fixing device according to claim 12, wherein said predetermined angle of inclination has a value comprised between 0.1° and 45°.

14. The fixing device according to claim 13, wherein said predetermined angle of inclination has a value comprised between 1° and 20°.

15. The fixing device according to claim 14, wherein said predetermined angle of inclination has a value comprised between 1° and 5°.

16. The fixing device according to claim 12, wherein said first flat gripping surface is defined in a first gripping element associated with said first fastening element and/or said second flat gripping surface is defined in a second gripping element associated with said second fastening element.

17. The fixing device according to claim 16, further comprising one or more spacer elements associated with said first fastening element to adjust the position of said first gripping element and/or further comprising one or more spacer elements associated with said second fastening element to adjust the position of said second gripping element.

18. The fixing device according to claim 12, wherein said first flat gripping surface is made of a material with high friction coefficient and/or said second flat gripping surface is made of a material with low friction coefficient adapted to favor the sliding movement on said second external face of said panel.

19. The fixing device according to claim 12, wherein said second fastening element comprises a plurality of rolling means having respective contact zones for said second external face of said panel,
wherein said contact zones lie on a plane which defines said second flat gripping surface or said first fastening element comprises a plurality of rolling means having respective contact zones for said first external face of said panel, and
wherein said contact zones lie on a plane which defines said first flat gripping surface.

20. The fixing device according to claim 12, wherein said first connection portion comprises a plurality of first contact surfaces and said second connection portion comprises a plurality of second contact surfaces,
wherein said first fastening element is connected to said second fastening element by means of the mutual sliding of said plurality of first contact surfaces and said plurality of second contact surfaces when said fastening elements (mutually slide along said sliding direction, and
wherein said plurality of first and second contact surfaces are parallel to each other and inclined, along said sliding direction, at said predetermined angle with respect to said first flat gripping surface.

21. The fixing device according to claim 12, further comprising connection means for connection to a load-bearing structure.

22. The fixing device according to claim 21, wherein said connection means are associated with said first fastening element or to said second fastening element.

23. The fixing device according to claim 22, wherein said connection means comprise one or more fastening screws and/or one or more dowels.

24. The fixing device according to claim 12, wherein the fixing device is part of a hinge for connection to a load-bearing structure.
